(19) United States
(12) Patent Application Publication
(10) Pub. No.: US 2018/0039279 A1
(43) Pub. Date: Feb. 8, 2018

(54) APPARATUS FOR AUTONOMOUSLY MODIFYING ENVIRONMENT INFORMATION AND METHOD FOR USING THE SAME

(71) Applicant: HON HAI PRECISION INDUSTRY CO., LTD., New Taipei (TW)

(72) Inventors: HORNG-JUING LEE, New Taipei (TW); TIEN-PING LIU, New Taipei (TW); SHU-FEN CHEN, New Taipei (TW); YU-CHIEN HSIAO, New Taipei (TW); YU-TAI HUNG, New Taipei (TW); FU-HSIUNG YANG, New Taipei (TW)

(21) Appl. No.: 15/394,977

(22) Filed: Dec. 30, 2016

(30) Foreign Application Priority Data
Aug. 4, 2016 (TW) 105124847

(51) Int. Cl. G05D 1/02

(52) U.S. Cl. CPC G05D 1/0274; G05D 1/0246

(57) ABSTRACT

An apparatus for autonomously modifying environment information comprises an autonomous mobile device, a data storage module, an image collection module, an artificial marker identification module, a data recording module, a data analysis module, a data modification module, and a plurality of artificial markers. The image collection module is used to collect an image and transmit the image to the artificial marker identification module. The artificial marker identification module receives the images and identifies a plurality of artificial markers of the image to achieve a positioning. The data recording module records a path surface environment change information and a movement information. The data analysis module analyzes the movement information to achieve an optimal movement information. The data modification module receives the path surface environment change information and the optimal movement information to modify the map and the map description file stored in the data storage module.

### CROSS-REFERENCE TO RELATED APPLICATIONS

This application claims all benefits accruing under 35 U.S.C. § 119 from TW Patent Application No. 105124847, filed on Aug. 4, 2016, in the TW Intellectual Property Office, the contents of which are hereby incorporated by reference.

### FIELD

The subject matter herein generally relates to an apparatus for autonomously modifying environment information and a method for using the same.

### BACKGROUND

Simultaneous localization and mapping (SLAM) are commonly used in an autonomous mobile device for positioning. SLAM means the autonomous mobile device starts from an unknown environment location, and establish its own location and posture by repeatedly observing map features during a movement; then incrementally constructing a map, so as to achieve a self-locating and map-constructing simultaneously. SLAM commonly achieves positioning by more information from the sensor, such as GPS, IMU, Odometry. When the autonomous mobile device moves by universal wheel or omni wheel, the odometry can not provide a reference to a moving distance, and the GPS also can not be used in an interior room environment.

Presently, people use an artificial marker to achieve computer vision positioning, and they do not use IMU to achieve positioning. However, when one same autonomous mobile device is in different environmental conditions, the same motor output can not reach the same moving distance. Although the autonomous mobile device can reach the destination, the autonomous mobile devices will move clumsily.

### BRIEF DESCRIPTION OF THE DRAWING

Implementations of the present technology will now be described, by way of example only, with reference to the attached figures, wherein:

FIG. 1 is a schematic view of a module of an apparatus for autonomously modifying environment information to one embodiment.

FIG. 2 is a flow chart of a method of using the apparatus for autonomously modifying environment information to one embodiment.

FIG. 3 is a schematic view of a robot moving in an area of example 1.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature described, such that the component need not be exactly conforming to such feature. The term “comprise,” when utilized, means “include, but not necessarily limited to”; it specifically indicates open-ended inclusion or membership in the so-described combination, group, series, and the like.

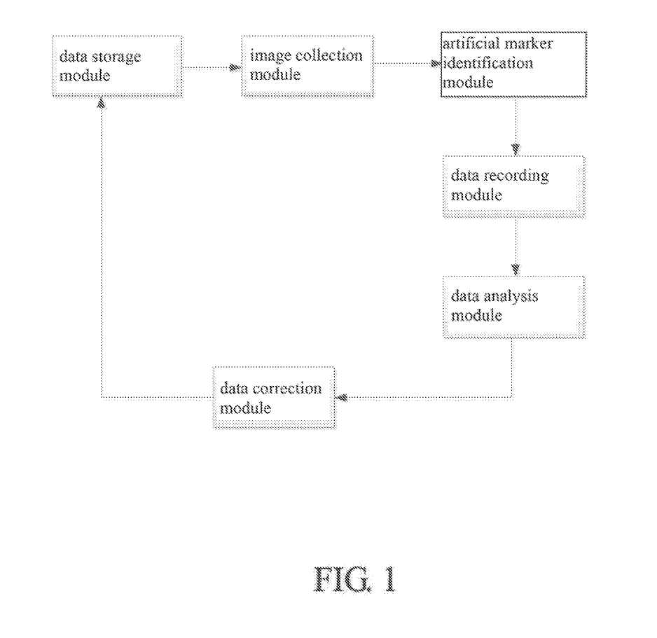

Referring to FIG. 1, the present disclosure is described in relation to an apparatus for autonomously modifying environment information. The apparatus for autonomously modifying environment information comprises an autonomous mobile device, a data storage module, an image collection module, an artificial marker identification module, a data recording module, a data analysis module, a data modification module and a plurality of artificial markers. The data storage module, the image collection module, the artificial marker identification module, the data recording module, the data analysis module and the data modification module can be located in the autonomous mobile device. The data storage module is used to store a map of a desired moving area and a map description file corresponding to the map. The plurality of artificial markers are located in the desired moving area, and the autonomous mobile device is configured to move between the plurality of artificial markers and provide a movement information. The image collection module is used to collect an image in front of the autonomous mobile device during movement and transmit the image to the artificial marker identification module. The artificial marker identification module is used to receive the images outputted by the image collection module and identify the plurality of artificial markers of the image to achieve a positioning. The data recording module is used to record a path surface environment change information and the movement information when the autonomous mobile device moves between the plurality of artificial markers. The data analysis module is used to analyze the movement information to achieve an optimal movement information. The data modification module is used to receive the path surface environment change information and the optimal movement information to modify the map and the map description file stored in the data storage module.

The autonomous mobile device can be any mobile device, such as a robot or unmanned vehicle. The autonomous mobile device moves by a foot or a wheel.

The desired moving area can be a workplace, such as a workshop, a restaurant, or a tourist station. The plurality of artificial markers is located in the desired moving area. Each artificial marker corresponds to an ID. The ID may include a number, a character, etc. The ID represents a name of the artificial marker, such as a corner. The artificial markers can be Tag36h11 marker series, Tag36h10 marker series, Tag25h9 marker series, or Tag16h5 marker series.

The data storage module stores the map of the desired moving area and the map description file corresponding to the map. The map is stored in a designated mark language (XML) or another format file, wherein the artificial marker is defined. The map description file includes a description of a vicinity of the artificial marker in the map and the movement information between two artificial markers. The map description file may be a place name marked by the artificial marker on the map, and a distance, a direction and a required motor output and other information when the autonomous mobile device moves from one artificial marker to next artificial marker. The data storage module may only store a modified movement information for a same path surface environment, or may also store the modified movement information on the basis of retaining an original movement information. The autonomous mobile device moves from an artificial marker A to an artificial marker B, in one embodiment, a movement information “5 steps straight ahead of the artificial marker A and then back 1 step to reach the artificial marker B” has been stored in the data storage module. And then, another movement information “4 steps straight ahead of the artificial marker A to reach the artificial marker B” can be used to replace the movement information “5 steps straight ahead of the artificial marker A and then back 1 step to reach the artificial marker B.”

The image collection module comprises a camera. The camera is located on the side of the autonomous mobile device facing a direction of movement to capture the image in a field of view, so as to be capable of capturing the artificial marker. The image collection module transmits the image to the artificial marker identification module through a data line. The camera can be a web camera based on Charge-coupled Device (CCD) or Complementary Metal Oxide Semiconductor (CMOS).

The artificial marker identification module receives the image captured by the image collection module, and reads and identifies the artificial marker in the image to determine a position and an angle of the autonomous mobile device relative to the artificial marker, so as to realize positioning. When the path surface environment between the artificial markers is changed, the autonomous mobile device moves from the artificial mark A to the artificial mark B according to a stored map description file firstly; and when the autonomous mobile device find that it is at a lower left of the artificial mark B, the autonomous mobile device can autonomously position and make a corresponding processing command to reach directly below the artificial mark B. When the path surface environment between the artificial markers is unchanged, the autonomous mobile device can reach directly below the artificial mark B according to the stored map description file. There is no need for self-modification.

The data recording module is used to record the path surface environment change information and the movement information between the plurality of artificial markers. The path surface environment change information includes an appearance or disappearance of an obstacle, a change of the path surface friction coefficient. For example, a number of obstacles suddenly appear on the map, such as tables, chairs, or the ground covered with carpets, sand, stones and other objects. The movement information includes a number of displacement modification times and a displacement modification amount when the autonomous mobile device moves between the plurality of artificial markers. In one embodiment, a path surface environment changes, such as, a table is placed on the path, the data recording module records an obstacle, the number of displacement modification times of the autonomous mobile device bypassing the obstacle, and the displacement modification amount for each time. In another embodiment, the path surface friction coefficient changes, such as, a carpet is placed on the path, the autonomous mobile device moves on the carpet, the data recording module records the number of displacement modification times of the autonomous mobile device bypassing the obstacle, and the displacement modification amount for each time.

The data analysis module is connected to the data recording module. The movement information recorded by the data recording module is analyzed by the data analysis module in two parts. In the first part, when a new obstacle appears on the path, the data analysis module analyzes the movement information of the autonomous mobile device bypassing the new obstacle and judges whether there is the optimal movement information. In the second part, when the path surface friction coefficient changes, the data analysis module analyzes the movement information obtained by the autonomous mobile device moving on a path surface and judges whether a number of displacement modification times is greater than a threshold value. The threshold value refers to a set critical values according to an actual situation.

The data modification module is respectively connected to the data storage module and the data analysis module. The data modification module is used for modifying the map and the map description file stored in the data storage module. When the new obstacle is placed on the path, the data modification module modifies the map and the map description file. When the path surface friction coefficient changes, the data modification module only modifies the map description file.

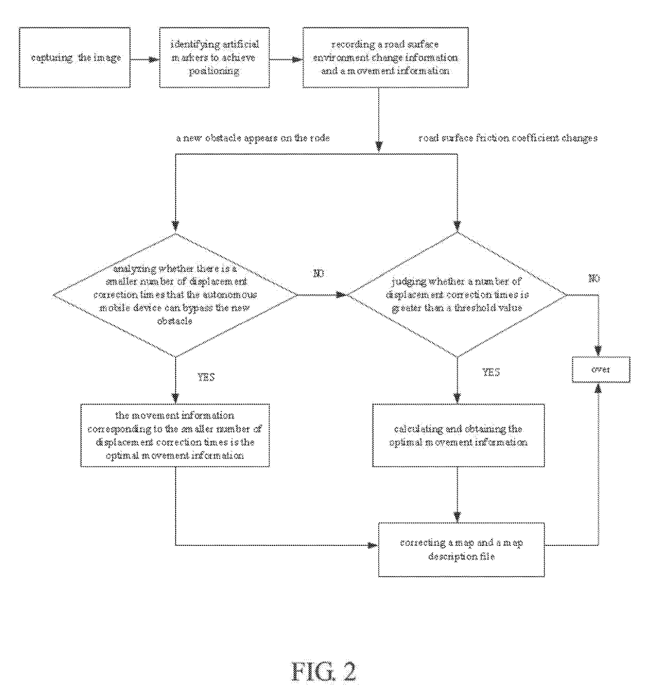

FIG. 2 illustrates one embodiment of a method of using the apparatus for autonomously modifying environment information comprising the following steps:

S1: providing the apparatus for autonomously modifying environment information comprising an autonomous mobile device, a data storage module, an image collection module, an artificial marker identification module, a data recording module, a data analysis module, a data modification module and a plurality of artificial markers;

S2: activating the autonomous mobile device to move between the plurality of artificial markers, collecting an image in front of the autonomous mobile device during a movement of the autonomous mobile device by the image collection module, and transmitting the image to the artificial marker identification module;

S3: identifying the plurality of artificial markers in the image by the artificial marker identification module, and determining a position of the autonomous mobile device relative to the plurality of artificial markers;

S4: recording a path surface environment change information between the plurality of artificial markers and a movement information of the autonomous mobile device moving between the plurality of artificial markers by the data recording module, and judging an optimal movement information between the plurality of artificial markers according to the movement information by the data analysis module; and

S5: modifying a map and a map description file in the data storage module according to the path surface environment change information and the optimal movement information by the data modification module.

In step S3, the image collection module outputs the image marked with the artificial marker to the artificial marker identification module. The artificial marker identification module identifies the ID of the artificial marker and judges a distance and an angle of the autonomous mobile device relative to the artificial marker. So that the autonomous mobile device can subsequently autonomously modify the movement information, such as motor output, output time, etc.

In step S4, there is a least number of displacement modification times of the autonomous mobile device moving from an artificial marker to next artificial marker. The optimal movement information refers to a movement of the least number of displacement modification times. A method of judging the optimal movement information according to the movement information by the data analysis module can comprise the following steps:

S41: when a path surface environment includes a new obstacle, recording a number of displacement modification times of the autonomous mobile device bypassing the new obstacle, and analyzing whether there is a smaller number of displacement modification times that the autonomous mobile device can bypass the new obstacle by the data analysis module; when “yes”, the movement information corresponding to the smaller number of displacement modification times is the optimal movement information ; when “no”, the movement information corresponding to the number of the displacement modification time recorded before is the optimal movement information; and

S42: when the path surface friction coefficient changes, recording the number of displacement modification times and a displacement modification amount when the autonomous mobile device moves on the path surface, and analyzing whether the number of displacement modification times is greater than a threshold value by the data analysis module; when “yes”, calculating and obtaining the optimal movement information according to the number of displacement modification times and the displacement modification amount by the data analysis module; when “no”, the movement information corresponding to the number of the displacement modification times recorded before is the optimal movement information.

In step S42, in one embodiment, the data analysis module obtains the optimal movement information based on an average value of the number of displacement modification times and the displacement modification amount.

In step S5, when the new obstacle appears or disappears in the path surface environment, the new obstacle is added or deleted in a pre-stored map, and the pre-stored movement information in the map description file is modified to the optimal movement information. When the path surface friction coefficient changes, the pre-stored movement information in the map description file is modified to the optimal movement information.

The map and the map description file stored in the autonomous mobile device can be modified by continuously executing the steps S4 to S5, so that the autonomous mobile device can gradually move smoothly.

In the apparatus for autonomously modifying environment information and a method for the same, the map of the desired moving area and the map description file corresponding to the map are pre-stored in the autonomous mobile device. The path surface environment change information and the movement information during movement between the plurality of artificial markers are recorded to analyze and determine the optimum movement information. The map and the map description file pre-stored in the autonomous mobile device can be continuously modified. Thus, the autonomous mobile device can move more smoothly in the desired moving area.

### EXAMPLE 1

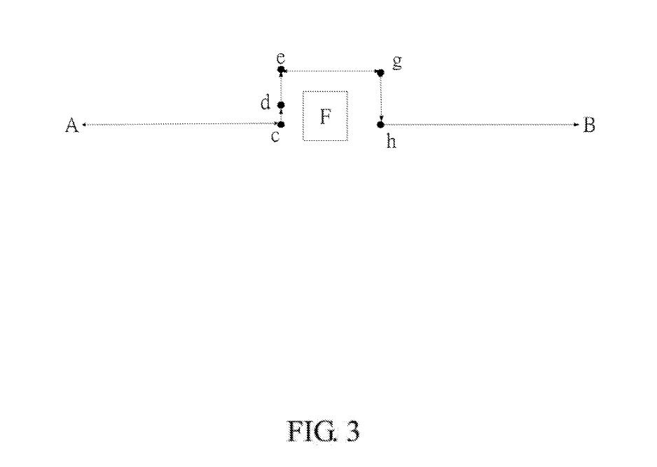

Referring to FIG. 3, a robot moves within an area of a plant. An artificial marker A and an artificial marker B are located in the area. The robot moves from the artificial marker A to the artificial marker B. A new obstacle F is located in the area. When the robot moves to point c according to the pre-stored information, the robot finds that it can not continuously move forward. Then the robot autonomously moves to left by 1 step to reach the point d and finds that it can not move forward according to an original route. Then the robot continuously moves to left by 3 steps to reach the point e and finds that it can move forward according to the original route. The robot continuously moves forward by 4 steps to reach the point g and continuously moves right by 4 steps to reach the point h and then reaches the artificial mark B according to the original route. In the above process, the number of the displacement modification times is 4. There is only one displacement modification when the robot moves from point c to point e through analysis. The robot will increase the new obstacle F in the map, and modify the movement information in the map description file. So that the robot only needs to modify the displacement three times when it moves from the artificial marker A to the artificial marker B next time. The map description file can be continuously modified when the number of displacement modification times is smaller than three.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. An apparatus for autonomously modifying environment information, comprising:
a data storage module configured to store a map of a desired moving area and a map description file corresponding to the map, wherein a plurality of artificial markers are located in the desired moving area;
an autonomous mobile device configured to move between the plurality of artificial markers and provide a movement information;
an image collection module located in the autonomous mobile device and configured to collect an image in front of the autonomous mobile device;
an artificial marker identification module located in the autonomous mobile device and configured to receive the image outputted by the image collection module and identify the plurality of artificial markers in the image to achieve a positioning information of the autonomous mobile device;
a data recording module located in the autonomous mobile device and configured to record a path surface environment change information and the movement information;
a data analysis module configured to analyze the movement information to achieve a preferred movement information; and
a data modification module configured to receive the path surface environment change information and the preferred movement information to modify the map and the map description file stored in the data storage module.

2. The apparatus of claim 1, wherein the plurality of artificial markers are selected from a group consisting of Tag36h11 marker series, Tag36h10 marker series, Tag25h9 marker series, and Tag16h5 marker series.

3. The apparatus of claim 1, wherein the map description file stores a distance, a direction, and a required motor output between two artificial markers.

4. The apparatus of claim 3, wherein the movement information comprises a number of displacement modification times and a displacement modification amount when the autonomous mobile device moves between the two artificial markers.

5. The apparatus of claim 1, wherein the path surface environment change information comprises an appearance or disappearance of an obstacle and a change of a path surface friction coefficient.

6. The apparatus of claim 1, wherein the image collection module comprises a camera, and the camera is located on a side of the autonomous mobile device facing a direction of movement to capture the image in a field of view.

7. The apparatus of claim 6, wherein the camera is a web camera based on Charge-coupled Device or Complementary Metal Oxide Semiconductor.

8. A method of using an apparatus for autonomously modifying environment information comprising:
S1: providing the apparatus for autonomously modifying environment information comprising an autonomous mobile device, a data storage module, an image collection module, an artificial marker identification module, a data recording module, a data analysis module, a data modification module and a plurality of artificial markers ;
S2: activating the autonomous mobile device to move between the plurality of artificial markers, collecting an image in front of the autonomous mobile device during movement by the image collection module, and transmitting the image to the artificial marker identification module;
S3: identifying the plurality of artificial markers in the image by the artificial marker identification module, and determining a position of the autonomous mobile device relative to the plurality of artificial markers;
S4: recording a path surface environment change information between the plurality of artificial markers and a movement information of the autonomous mobile device moving between the plurality of artificial markers by the data recording module, and judging a preferred movement information between the plurality of artificial markers according to the movement information by the data analysis module; and
S5: modifying a map and a map description file in the data storage module according to the path surface environment change information and the preferred movement information by the data modification module.

9. The method of claim 8, wherein the preferred movement information is a least number of displacement modification times of the autonomous mobile device bypassing a new obstacle.

10. The method of claim 8, wherein a method of judging the preferred movement information according to the movement information by the data analysis module comprises:
S41: when a path surface environment comprises a new obstacle, recording a number of displacement modification times of the autonomous mobile device bypassing the new obstacle, and analyzing whether there is a smaller number of displacement modification times that the autonomous mobile device can bypass the new obstacle by the data analysis module; when “yes”, the movement information corresponding to the smaller number of displacement modification times is the preferred movement information ; when “no”, the movement information corresponding to the number of the displacement modification time recorded before is the preferred movement information; and
S42: when a path surface friction coefficient changes, recording the number of displacement modification times and a displacement modification amount when the autonomous mobile device moves on a path surface, and analyzing whether the number of displacement modification times is greater than a threshold value by the data analysis module; when “yes”, calculating and obtaining the preferred movement information according to the number of displacement modification times and the displacement modification amount by the data analysis module; when “no”, the movement information corresponding to the number of the displacement modification times recorded before is the optimal movement information.

11. The method of claim 10, wherein the threshold value refers to a set critical value according to an actual situation.

12. The method of claim 10, wherein the data analysis module obtains the preferred movement information based on an average value of the number of displacement modification times and the displacement modification amount in the S42.

13. The method of claim 8, wherein when a new obstacle appears on a path, the data modification module modifies the map and the map description file; and when a path surface friction coefficient changes, the data modification module only modifies the map description file.
